(19) United States
(12) Patent Application Publication
(10) Pub. No.: US 2026/0093337 A1
(43) Pub. Date: Apr. 2, 2026

(54) GESTURE-BASED SELECTION AND TRANSFER OF CONTENT

(71) Applicant: Apple Inc., Cupertino, CA (US)

(72) Inventors: Peter BURGNER, Venice, CA (US); Jiahui CHEN, San Francisco, CA (US); Guilherme KLINK, Campbell, CA (US)

(21) Appl. No.: 19/331,960

(22) Filed: Sep. 17, 2025

Related U.S. Application Data
(60) Provisional application No. 63/700,667, filed on Sep. 28, 2024.

(51) Int. Cl. G06F 3/01; G06F 3/04815; G06F 3/0482; G06V 20/20

(52) U.S. Cl. CPC G06F 3/017; G06F 3/04815; G06V 20/20; G06F 3/0482

(57) ABSTRACT

Examples of the disclosure are directed to systems and methods for acquiring and transferring content associated with objects that are displayed in a three-dimensional environment. While a computer system displays a three-dimensional environment that includes a first object and a first electronic device, the computer system detects that a user is performing a first gesture directed at the first object. In response to detecting the first gesture directed at the first object, the computer system collects information associated with the first object. The computer system detects the user performing a second gesture directed to a first electronic device (e.g., a laptop or other computing device). In response to detecting the second gesture directed to the first electronic device, the computer system transmits the collected information associated with the first object to the first electronic device.

### CROSS REFERENCE TO RELATED APPLICATIONS

This application claims the benefit of U.S. Provisional Application No. 63/700,667, filed Sep. 28, 2024, the content of which is herein incorporated by reference in its entirety for all purposes.

### FIELD OF THE DISCLOSURE

This relates generally to systems and methods for gesture-based selection and transfer of content within a three-dimensional environment.

### BACKGROUND OF THE DISCLOSURE

Some computer systems include cameras configured to capture images and/or video. Some computer systems, using the cameras, display three-dimensional environments that include representations of physical real-world objects as well as virtual objects.

### SUMMARY OF THE DISCLOSURE

Some examples of the disclosure are directed to systems and methods for acquiring and transferring content associated with objects that are presented in a three-dimensional environment. In one or more examples, while a computer system presents a three-dimensional environment that includes a first object and optionally a first electronic device, the computer system detects that a user is performing a first gesture directed at the first object. In one or more examples, in response to detecting the first gesture directed at the first object, the computer system collects information associated with the first object and stores the collected information in a memory associated with the computer system. In one or more examples, and after the information associated with the first object has been stored in the memory associated with the electronic device, the device detects the user performing a second gesture (that is optionally different from the first gesture) directed to the first electronic device (e.g., a laptop or other computing device that is in the physical environment of the user and is visible in the displayed three-dimensional environment). In one or more examples, in response to detecting the second gesture directed to the first electronic device, the computer system transmits the collected information associated with the first object to the first electronic device.

In one or more examples, the collected information associated with the first object includes a visual scan of the first object collected from one or more cameras of the computer system. Additionally or alternatively, upon collecting the visual scan of the first object, the computer system compares the visual scan (including text acquired as part of or after the visual scan, such as using optical character recognition) with one or more database entries to determine whether the first object is relevant to one or more items of media content. When a match is found, information about the relevant media content is added to the collected information associated with the first object. In one or more examples, the first object can include an electronic device running one or more software applications. Optionally, in response to detecting the first gesture directed to the electronic device, the computer system collects information about the one or more software applications that are running on the electronic device.

In one or more examples, the first electronic device includes a media device such as a smart speaker, music player, and/or video player. In some examples, in response to detecting that the second gesture is directed to a media device, the computer system transmits the information about media content that is relevant to the first object, so that the media player can play the media content that is relevant to the first object. In one or more examples, the second gesture can be directed to the computer system itself. Optionally, in response to detecting that the second gesture is directed to the computer system, the computer system displays a visual representation of the collected information associated with the first object in the three-dimensional environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3N illustrate an example system for collecting and transmitting content in a three-dimensional environment according to some examples of the disclosure.

FIG. 4 illustrates an example flow diagram illustrating a method of collecting and transmitting content within a three-dimensional environment according to some examples of the disclosure.

### DETAILED DESCRIPTION

Some examples of the disclosure are directed to systems and methods for acquiring and transferring content associated with objects that are displayed in a three-dimensional environment. In one or more examples, while a computer system presents a three-dimensional environment that includes a first object and a first electronic device, the computer system detects that a user is performing a first gesture directed at the first object. In one or more examples, in response to detecting the first gesture directed at the first object, the computer system collects information associated with the first object and stores the collected information in a memory associated with the electronic device. In one or more examples, and after the information associated with the first object has been stored in the memory associated with the electronic device, the device detects the user performing a second gesture directed to the first electronic device (e.g., a laptop or other computing device that is in the physical environment of the user and is visible in the displayed three-dimensional environment). In one or more examples, in response to detecting the second gesture directed to the first electronic device, the computer system transmits the collected information associated with the first object to the first electronic device.

In one or more examples, the information associated with the first object includes a visual scan of the first object collected from one or more cameras of the computer system. Additionally or alternatively, upon collecting the visual scan of the first object, the computer system compares the visual scan (including text acquired as part of the visual scan) with one or more database entries to determine if the first object is relevant to one or more items of media content, and if a match is found, information about the relevant media content is added to the collected information associated with the first object. In one or more examples, the first object can include an electronic device running one or more software applications. Optionally, in response to detecting the first gesture directed to the electronic device, the computer system collects information about the one or more software applications that are running on the electronic device.

In one or more examples, the first electronic device includes a media device such as a smart speaker, music player, and/or video player. In some examples, in response to detecting that the second gesture is directed to a media device, the computer system transmits the information about media content that is relevant to the first object, so that the media player can play the media content that is relevant to the first object. In one or more examples, the second gesture can be directed to the computer system itself. Optionally, in response to detecting that the second gesture is directed to the computer system, the computer system displays a visual representation of the collected information associated with the first object in the three-dimensional environment.

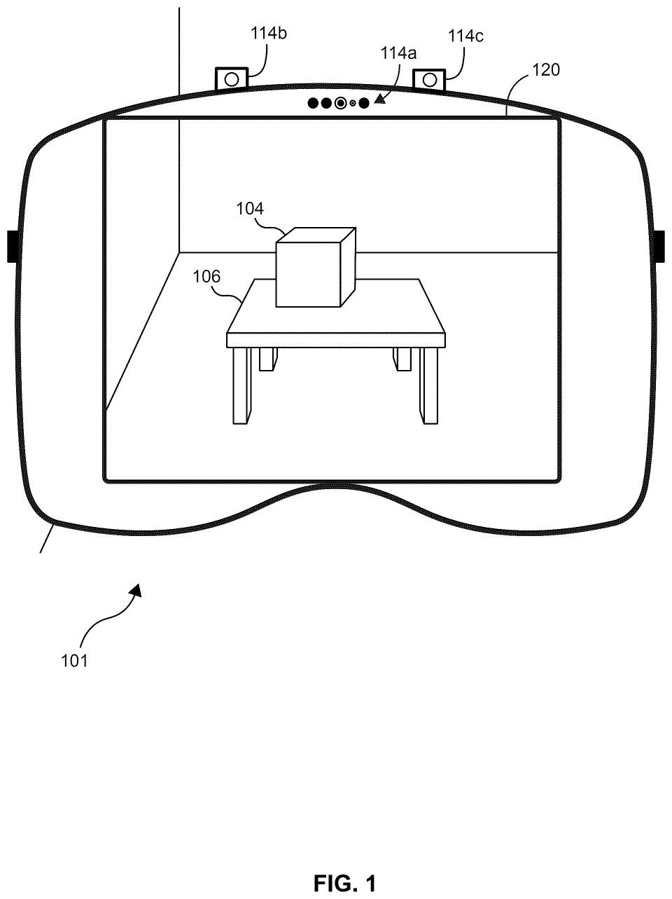

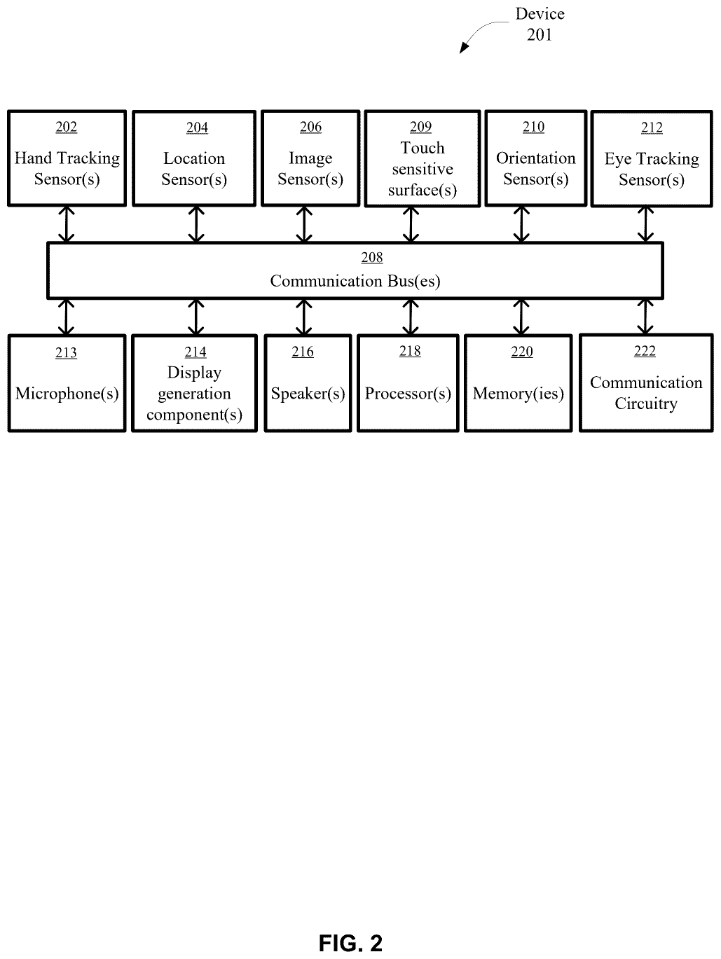

FIG. 1 illustrates a computer system 101 presenting an extended reality (XR) environment (e.g., a computer-generated environment optionally including representations of physical and/or virtual objects) according to some examples of the disclosure. In some examples, as shown in FIG. 1, computer system 101 is a head-mounted display or other head-mountable device configured to be worn on a head of a user of the computer system 101. Additionally or alternatively, computer system 101 can be any computing system (such as a mobile phone) in which one or more cameras produce images of the environment of the user and can superimpose virtual objects onto a displayed environment. Examples of computer system 101 are described below with reference to the architecture block diagram of FIG. 2. As shown in FIG. 1, computer system 101 and table 106 are located in a physical environment. The physical environment may include physical features such as a physical surface (e.g., floor, walls) or a physical object (e.g., table, lamp, etc.). In some examples, computer system 101 may be configured to detect and/or capture images of physical environment including table 106 (illustrated in the field of view of computer system 101).

In some examples, as shown in FIG. 1, computer system 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, computer system 101 also includes external image sensors 114b and 114c facing outwards from the user to detect and/or capture the physical environment of the computer system 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, computer system 101 may be an optical see-through device in which display 120 is a transparent or translucent display through which portions of the physical environment may be directly viewed. In some examples, display 120 may be included within a transparent lens and may overlap all or only a portion of the transparent lens. In other examples, computer system 101 may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the computer system 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the computer system 101 in response to detecting the planar surface of table 106 in the physical environment 100.

In some examples, the display 120 is provided as a passive component (e.g., rather than an active component) within computer system 101. For example, the display 120 may be a transparent or translucent display, as mentioned above, and may not be configured to display virtual content (e.g., images of the physical environment captured by external image sensors 114b and 114c and/or virtual object 104). Alternatively, in some examples, the computer system 101 does not include the display 120. In some such examples in which the display 120 is provided as a passive component or is not included in the computer system 101, the computer system 101 may still include sensors (e.g., internal image sensor 114a and/or external image sensors 114b and 114c) and/or other input devices, such as one or more of the components described below with reference to FIG. 2.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the computer system as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the computer system. In some examples, objects displayed in the three-dimensional environment may be moved and/or reoriented in the three-dimensional environment in accordance with movement input detected via the input device.

In the discussion that follows, a computer system that is in communication with a display generation component and one or more input devices is described. It should be understood that the computer system optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described computer system, display and touch-sensitive surface are optionally distributed amongst two or more devices. Therefore, as used in this disclosure, information displayed on the computer system or by the computer system is optionally used to describe information outputted by the computer system for display on a separate display device (touch-sensitive or not). Similarly, as used in this disclosure, input received on the computer system (e.g., touch input received on a touch-sensitive surface of the computer system, or touch input received on the surface of a stylus) is optionally used to describe input received on a separate input device, from which the computer system receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more computer systems. For example, the computer system 201 may be a portable device, an auxiliary device in communication with another device, a head-mounted display, etc., respectively. In some examples, computer system 201 corresponds to computer system 101 described above with reference to FIG. 1.

As illustrated in FIG. 2, the computer system 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of computer systems 201.

Communication circuitry 222 optionally includes circuitry for communicating with computer systems, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, computer system 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with computer system 201 or external to computer system 201 that is in communication with computer system 201).

Computer system 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from computer system 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, computer system 201 uses CCD sensors, event cameras, and depth sensors in combination to detect the physical environment around computer system 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, computer system 201 uses image sensor(s) 206 to detect the position and orientation of computer system 201 and/or display generation component(s) 214 in the real-world environment. For example, computer system 201 uses image sensor(s) 206 to track the position and orientation of display generation component(s) 214 relative to one or more fixed objects in the real-world environment.

In some examples, computer system 201 includes microphone(s) 213 or other audio sensors. Computer system 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Computer system 201 includes location sensor(s) 204 for detecting a location of computer system 201 and/or display generation component(s) 214. For example, location sensor(s) 204 can include a global positioning system (GPS) receiver that receives data from one or more satellites and allows computer system 201 to determine the device's absolute position in the physical world.

Computer system 201 includes orientation sensor(s) 210 for detecting orientation and/or movement of computer system 201 and/or display generation component(s) 214. For example, computer system 201 uses orientation sensor(s) 210 to track changes in the position and/or orientation of computer system 201 and/or display generation component(s) 214, such as with respect to physical objects in the real-world environment. Orientation sensor(s) 210 optionally include one or more gyroscopes and/or one or more accelerometers.

Computer system 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Computer system 201 is not limited to the components and configuration of FIG. 2, but can include fewer, other, or additional components in multiple configurations. In some examples, computer system 201 can be implemented between two computer systems (e.g., as a system). In some such examples, each of (or more) computer system may each include one or more of the same components discussed above, such as various sensors, one or more display generation components, one or more speakers, one or more processors, one or more memories, and/or communication circuitry. A person or persons using computer system 201, is optionally referred to herein as a user or users of the system.

Attention is now directed towards interactions with physical objects in the physical environment (e.g., presented in the three-dimensional environment). The interactions may also be applied to one or more virtual objects and/or visual representation of real-world objects that are displayed in a three-dimensional environment presented at a computer system (e.g., corresponding to computer system 201).

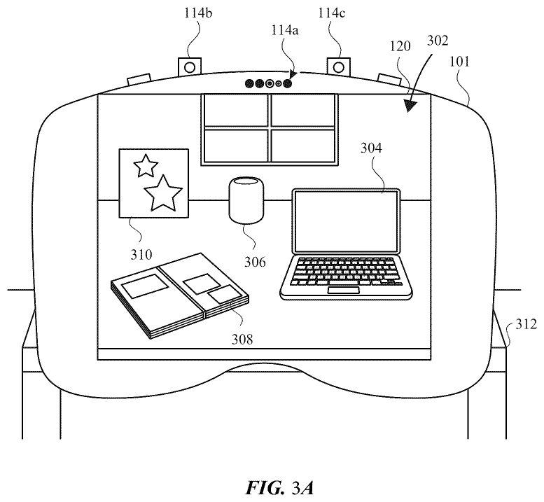

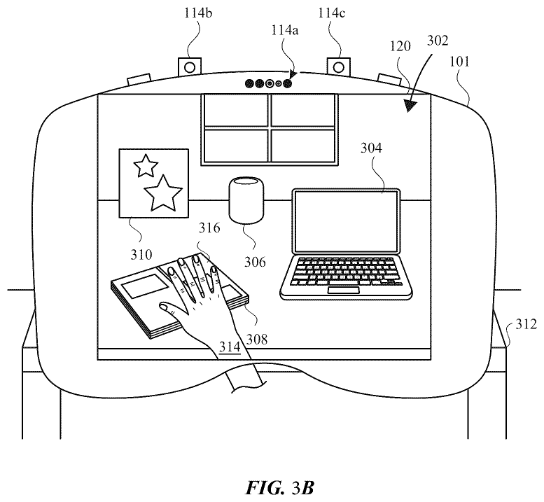

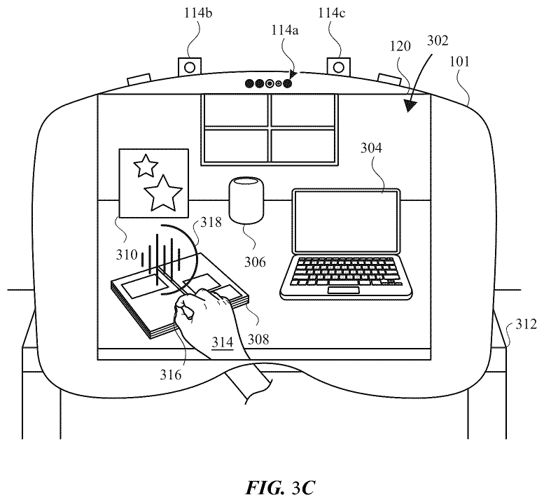

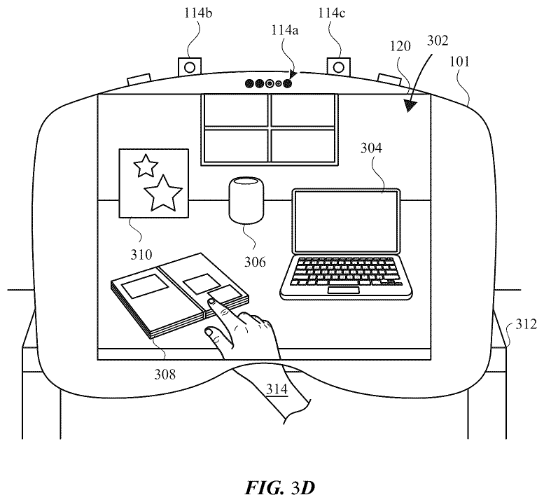

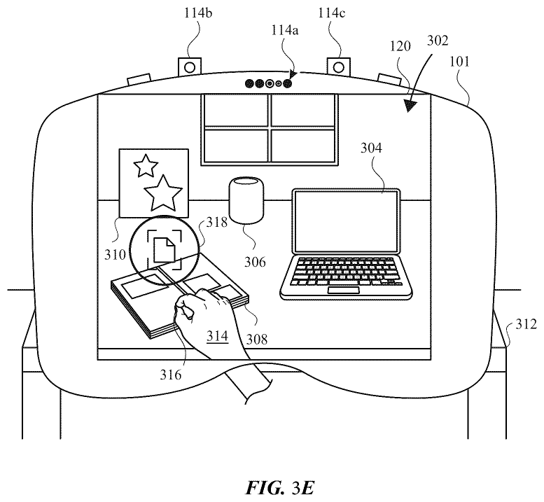

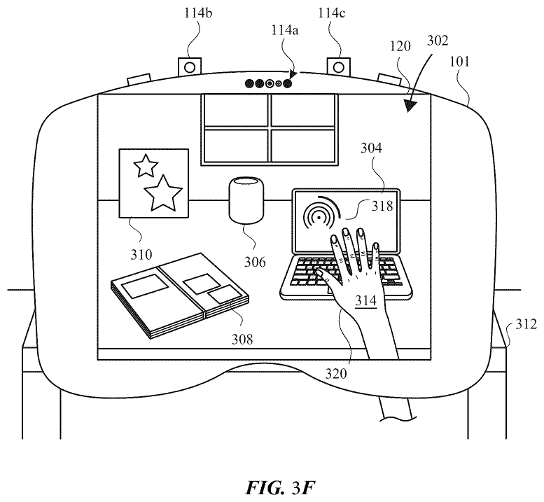

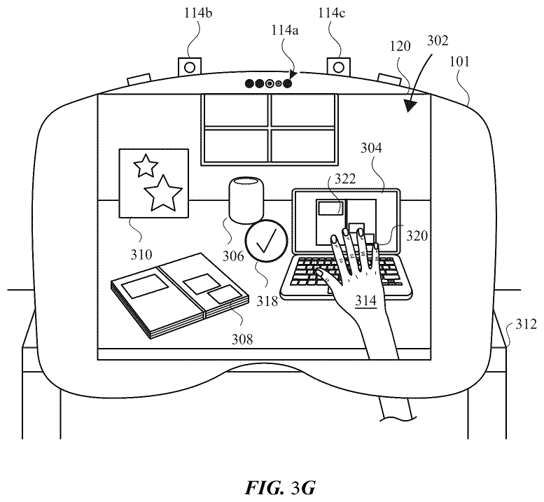

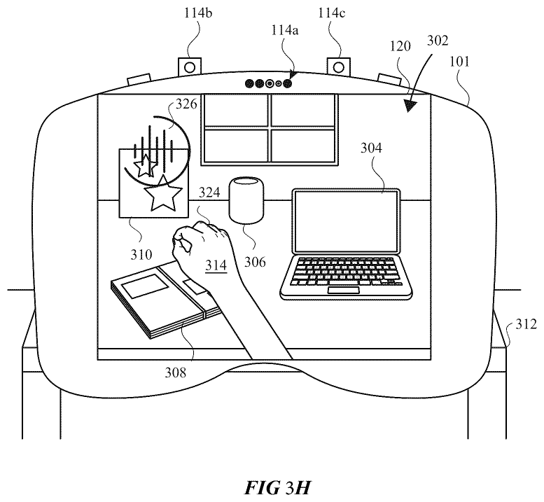

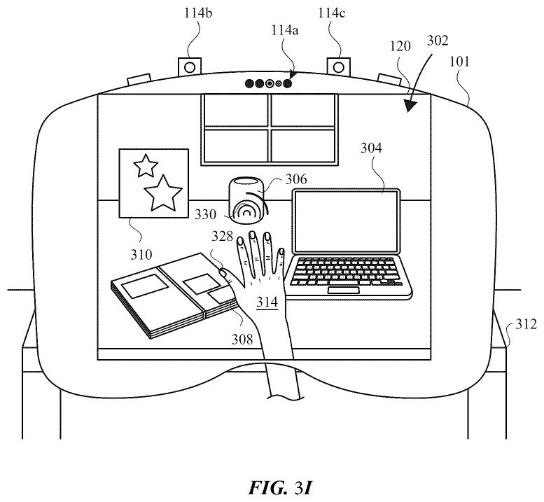

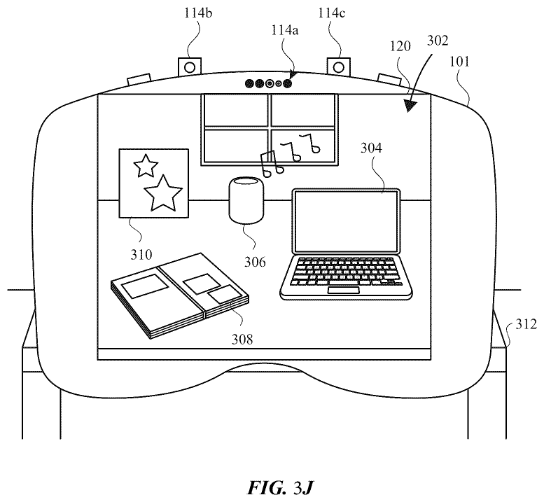

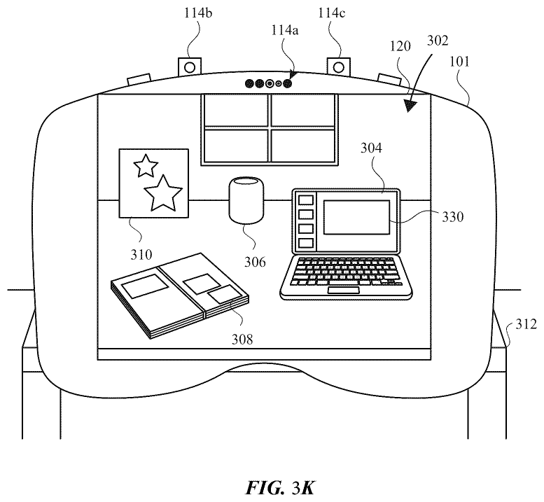

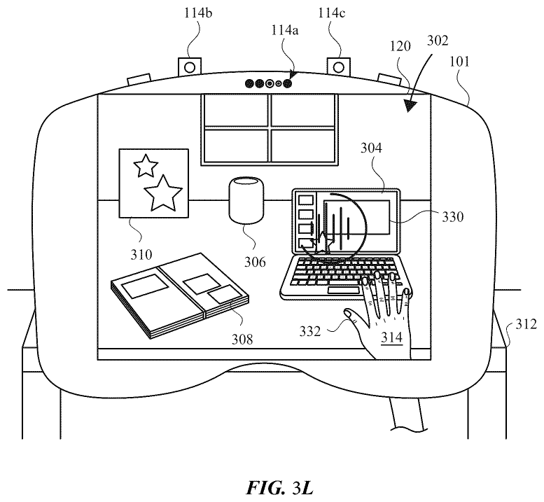

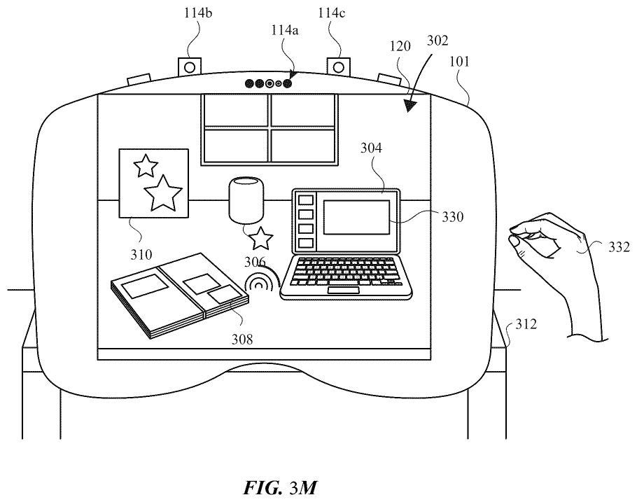

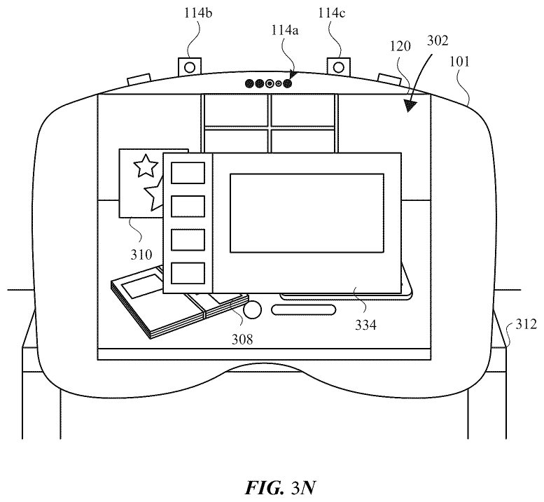

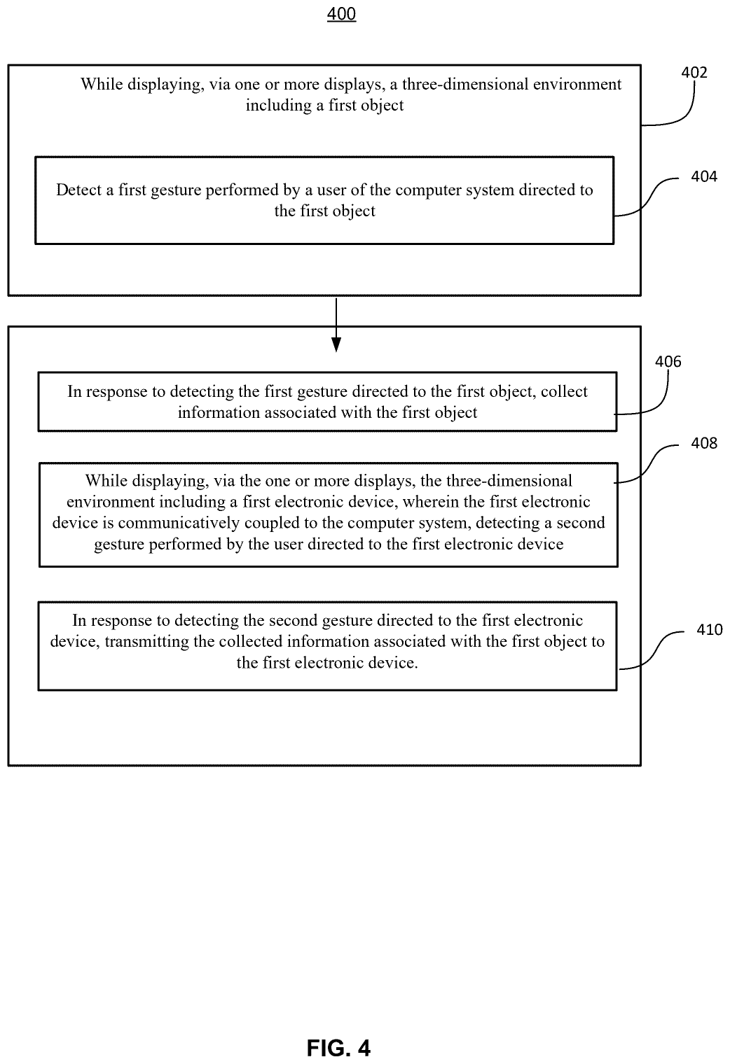

FIGS. 3A-3N illustrate an example system for collecting and transmitting content in a three-dimensional environment according to some examples of the disclosure. FIG. 3A illustrates an example three-dimensional environment 302 that is presented by computer system 101. In one or more example, three-dimensional environment 302 presented by computer system 101 includes one or more representations of physical objects that are in the surrounding real-world environment of the user of the computer system 101. For instance, as illustrated in FIG. 3A, three-dimensional environment 302 includes table 312 (at least the portion of table 312 that is visible in the field of view of computer system 101 and is presented on display 120 of computer system 101). In one or more examples, real-world objects that are laying on or near table 312 are also presented as part of three-dimensional environment 302. For instance, and as illustrated in FIG. 3A, three-dimensional environment 302 includes book 308, smart speaker 306, music album 310, and laptop 304.

In one or more examples, laptop 304 is a laptop that the user of computer system 101 is in control of, or is authorized to transmit communications to, from the computer system 101 (for instance because the user of both laptop 304 and computer system 101 have registered and/or logged in to each device using the same authorization credential). Thus, in some examples, the user of computer system 101 is authorized to transmit electronic data from computer system 101 to laptop 304 and/or receive data from laptop 304 to computer system 101. In one or more examples, if an authorized user of laptop 304 wanted to obtain a visual scanned copy of book 308 (e.g., the page and/or pages that are visible in three-dimensional environment 302) the user would have to manually obtain a scan of book 308 by placing the book in a dedicated scanning device that is communicatively coupled to the laptop 304 such that an image would be taken by the scanner and then transferred to laptop 304. In one or more examples, and as discussed in further detail below, the user of computer system 101 can employ the computer system 101 to perform scanning and other data collection operations that are initiated by a gesture performed by the user, which can be transferred to an electronic device as illustrated in FIGS. 3B-3G.

In one or more examples, the data collection gesture includes bringing together the fingers of a hand in a pinch directed at an object for a threshold period of time and/or pulling the hand maintaining pinch a threshold distance away from the object toward the computer system or the user of the computer system, as illustrated in FIGS. 3B-3C. For example, as illustrated in FIG. 3B, the user of computer system 101 using hand 314 initiates performance of a gesture 316 that is directed to book 308 (e.g., the gesture 316 is performed at a location in the three-dimensional environment that is overlapping with and/or proximate to book 308 (using a ray cast or other applicable method) such that computer system 101 recognizes that the gesture 316 is being directed to book 308). Optionally, and as illustrated in FIG. 3B, gesture 316 is initiated when the device detects that hand 314 of the user is outstretched with all fingers of the user being outstretched, followed by a motion of the hand 314 as illustrated in FIG. 3C. Optionally, in one or more examples, the fingers when initiating gesture 316 are apart from one another and not necessarily outstretched (e.g., partially outstretched, with back of the hand facing the user).

In one or more examples, and as illustrated in FIG. 3C, computer system 101 detects the continuance of gesture 316, and specifically that the outstretched hand 314 directed to book 308 moves such that one or more fingers of hand 314 come together (e.g., are pinched together) and the hand moves away from the target (such as book 308) as if the hand is pulling the information out of book 308 as illustrated in FIG. 3C. In some examples, gesture 316 is initiated when the finger tips come together in FIG. 3C rather than being initiated by the outstretched hand as illustrated in FIG. 3B. In such a scenario, the state of the hand in FIG. 3B is prior to the initiation of the gesture, whereas the state of the hand illustrated in FIG. 3C represents the hand performing gesture 316. In the example of FIG. 3C, computer system 101 detects that the gesture 316 that was initiated in FIG. 3B by outstretching hand 314 directed to book 308 continues with the user retracting one or more fingers of hand 314 such that the fingers come together in a pinching gesture. In the example of FIG. 3C, two fingers are shown coming together, however the number of fingers illustrated is exemplary, and could include more or less fingers. Specifically, in some examples, all five fingers can be used in the gesture, such that all five fingers come together and pull back to perform gesture 316.

In one or more examples, and in response to detecting that the user has performed gesture 316 and is continuing to hold the gesture (e.g., keeping the fingers pinched together, and the hand pulled back as described above) computer system 101 begins collecting information associated with book 308 (e.g., the object in three-dimensional environment 302 that the gesture 316 is directed to). In some examples, the collected information includes but is not limited to: a visual scan of book 308 using the one or more cameras 114a-c and/or text that is optically recognized on book 308. In one or more examples, computer system 101 displays a visual indicator 318 that is configured to provide a visual representation of the progress of the collection of information associated with book 308 in response to detection of gesture 316 directed to book 308. Optionally, the visual indicator includes a progress meter that gradually fills up over time as the collection of information progresses. For example, in the non-limiting example shown in FIG. 3C, the visual indicator 318 optionally includes an icon representing data collection with a progress ring around the icon. Alternatively and/or additionally, a visual representation of the progress of the gesture itself can be displayed. For example, the initial pinch (described above) causes a progress indicator to be displayed, and the progress indicator can be configured to illustrate how much the user needs to pull back the pinched fingers (in the manner described above) to complete the gesture.

In one or more examples, computer system 101 continues to collect the information associated with book 308 so long as the computer system detects the user holding gesture 316 and/or the computer system 101 detects that the collection of information associated with book 308 has been completed. For instance, as illustrated in FIG. 3D, computer system 101 detects that the user had terminated gesture 316 by un-pinching their fingers prior to the computer system 101 having collected all of the information associated with book 308. In response to detecting that the user has terminated gesture 316 in FIG. 3D, computer system 101 terminates the collection process without completing the process and does not store any information that was previously collected before the computer system 101 determined that the gesture was terminated. In this way, computer system 101 provides the user with the opportunity to cancel a previously initiated collection of information (e.g., an opportunity for the user to change their mind).

Alternatively, in one or more examples, computer system 101 terminates the collection of information associated with book 308 in response to the process completing as illustrated in FIG. 3E. In the example of FIG. 3E, and in response to computer system 101 determining that the user has held gesture 316 (and/or completed the gesture) during the collection process, computer system 101 completes the collection process. In one or more examples, computer systems 101 displays visual indicator 318 indicating completion. For example, as shown in FIG. 3E, the visual indicator 318 has transitioned from the appearance shown in FIG. 3C to that shown in FIG. 3E to provide a visual indication that information collection process has been completed. For example, the visual indication may transition an icon from one indicating data collection to one indicating completion (e.g., a checkmark) or an indication of the type of data collected (e.g., a document). Additionally or alternatively, the visual indication may cease to display the progress indication (e.g., cease displaying a ring). It is understood that other visual indication changes are possible such as changing the color or opacity of the visual indication. In one or more examples, in response to determining that the collection process has completed, computer system 101 stores the collected information in a memory that is associated with computer system (e.g., a memory that is physically located at computer system 101 and/or a memory that is communicatively coupled to computer system 101).

In one or more examples, the information that is stored in a memory associated with the computer system 101 in response to gesture 316 in FIGS. 3B-3E, can be transferred to an electronic device. In one or more examples, transferring the information to another electronic device requires the electronic device be within the field of view of the user of computer system 101 and/or within the field of view of sensors of computer system 101 as illustrated in FIGS. 3F-3G. In one or more examples, the data transfer gesture is a reverse of the data collection gesture. For example, the data transfer gesture includes separating the fingers of a hand (releasing a pinch) directed at an electronic device and/or pushing the hand while un-pinching a threshold distance toward the electronic device (away from the computer system or the user of the computer system), as illustrated in FIGS. 3F-3G. As illustrated in FIG. 3F, computer system 101 detects that the user performs gesture 320 directed to laptop 304 and in response transmits the collected and stored information associated with book 308 to laptop 304. In one or more examples, computer system 101 detects gesture 320 being performed when hand 314 is outstretched and pointed at an electronic device such as laptop 304.

In one or more examples, and in response to detecting gesture 320 (and when the computer system 101 has stored information collected using the process described above with respect to FIGS. 3B-3E), computer system 101 transmits the stored information associated with book 308 to laptop 304 using a pre-established communication link (e.g., a wired, wireless, and/or cloud-based communication link) between computer system 101 and laptop 304 (described above). In one or more examples, and similar to the gesture 316 used to initiate collection of the information associated with book 308, if computer system 101 detects that gesture 320 is terminated by the user prior to completion of the information associated with book 308 being transferred to laptop 304, computer system 101 terminates the process of transferring the information to laptop 304. In one or more examples, computer system 101 displays visual indicator 318 during the process of transferring the information to laptop 304 so as to provide a visual indication of the progress of the information transfer (similar to the example of visual indicator 318 described above). In some examples, visual indicator 318 transitions to an indication that the transfer of information associated with book 308 has been completed as illustrated in FIG. 3G.

In one or more examples, and as illustrated in FIG. 3G, computer system 101 displays visual indicator 318 that now indicates that the transmission of information associated with book from the computer system 101 to the laptop 304 has been completed. Additionally, as illustrated in FIG. 3G, laptop 304 optionally displays the scanned image 322 of book 308 that was collected and transmitted to the laptop in the examples described above. In some examples, and similar to the example of the information collection gesture described above, computer system 101 can display a visual indicator indicating the progress of the gesture.

In one or more examples, computer system 101 in addition to obtaining a visual scan of an object such as book 308 in three-dimensional environment can collect other types of information. For instance, and as described in further detail below, using the scan obtained from the processes described above, computer system 101 can obtain text or graphical information (e.g., pictures that appear in book 308). In one or more examples, computer system 101 compares the text or graphical information to one or more databases (such as a media database) to determine whether the book 308 is related to any media content items (such as music, movies, and/or television shows). In one or more examples, any relevant entries that are found as a result of the comparison can be recorded and stored along and as part of the information associated with book 308.

In one or more examples, in addition to computing devices such as laptop 304, computer system 101 can transmit the information/data collected and associated with book 308 to other types of devices. For instance, computer system 101 can transmit the information associated with an object to a multimedia device such as a smart television, smart hub, or smart speaker as illustrated in FIGS. 3H-3J. In the example of FIG. 3H, computer system 101 detects that the user initiates collection of information associated with music album 310 by performing gesture 324 (similar to gesture 316 described above), and in response computer system 101 collects information associated with music album 310 (as indicated by visual indicator 326). Optionally, the collected information associated with music album 310 includes a visual scan of music album 310 and also includes comparing information (e.g., texts and graphics) retrieved from the visual scan with one or more media databases to determine if there are any media content items that are relevant to music album 310. For instance, in the example of music album 310, the artwork and text obtained from a scan of music album 310 can be compared against a music database to determine if there are any music albums and/or songs that are associated with the album, and any matches can be added to the collected information associated with album 310. In one or more examples, computer system 101 can transmit portions of the collected information associated with an object (such as music album 310) based on the type of electronic device that the computer system 101 detects the user is intending to transmit the collected information to. For instance, in response to detecting that the user is transmitting the collected information associated with music album 310 to a smart speaker, computer system transmits information associated with music that is part of the collected information as illustrated in FIG. 3I.

In the example of FIG. 3I, computer system 101 detects that the user is performing gesture 328 directed to smart speaker 306. In one or more examples, computer system 101 determines that smart speaker 306 is a device that plays music. For instance, computer system 101 determines the category of electronic that smart speaker 306 is by using the scan data that is acquired as part of the collected information associated with smart speaker 306. In one or more examples, and in response to determining the type of electronic device that gesture 328 is directed to (e.g., smart speaker 306), computer system 101 transmits only the portion of the collected information associated with music album 310 to smart speaker 306. For instance, since smart speaker 306 is a music player, computer system 101 can transmit the portion of the collected information pertaining to the music that was found to be relevant to music album 310 (through the process of searching the media databases described above). In one or mor examples, and similar to the examples described above, computer system 101 displays a visual indicator 330 that provides a visual indication to the user of the progress of the transfer of data from computer system 101 to smart speaker 306. In one or more examples, once the transfer has been completed, smart speaker can begin playing the music (e.g., song and/or album) that was included in the information transmitted to smart speaker 306 from computer system 101 as illustrated in FIG. 3J. In some embodiments, the device that receives the transfer can perform an operation with the received information based on the contents of the received information. For instance, in the example of a smart speaker, the smart speaker plays a song based on the information contained in the received information (e.g., a song title, artist information, etc.)

As illustrated in FIG. 3J, smart speaker 306 in response to receiving the portion of the collected information pertaining to relevant music associated with music album 310 plays the music that has been identified as being associated music album 310. In one or more examples, as part of the process of transmitting the collected information to smart speaker 306, computer system 101 can send a command to smart speaker 306 instructing smart speaker 306 to play the music associated with the information that computer system 101 transmitted to smart speaker 306. Alternatively, smart speaker 306 automatically begins playing the music that is found in the transmitted information once it receives the information from computer system 101.

In some examples, the process of collecting information described above can be used by computer system 101 to generate virtual content in three-dimensional environment 302 as illustrated in FIGS. 3K-3N. In the example of FIG. 3K, three-dimensional environment 302 includes the same items that are presented by computer system 101 (e.g., laptop 304, smart speaker 306, book 308, and music album 310) in the example of FIG. 3A. However, in the example of FIG. 3K, laptop 304 is operating a presentation application 330 that is displayed on the display of laptop 304. In one or more examples, the user can collect information about the application that is running on laptop 304 using the same or similar gestures described above for collecting information about objects in three-dimensional environment 302 as illustrated in FIG. 3L.

As illustrated in FIG. 3L, computer system 101 initiates a process to collect information associated with application 330 in response to detecting gesture 332 performed by the hand 314 of the user of computer system 101. In one or more examples, computer system 101 detects that the object that gesture 332 is directed towards is a computing device that is running an application, and in response to the determination, transmits a request to laptop 304 to provide information about the application 330 it is running. For instance, the information includes information about the file and/or files that application 330 is using while operating. In some examples, laptop 304, in response to the request from computer system 101, transmits information about application 330 that enables computer system 101 to display and operate the application 330 in the three-dimensional environment 302 displayed on display 120 (e.g., in addition to or instead of on a display of laptop 304). In one or more examples, once the information associated with application 330 running on laptop 304 is collected by computer system 101, the computer system can display the application and/or a visual representation of the application in three-dimensional environment 302 in response to detecting a gesture as illustrated in FIG. 3M.

In the example of FIG. 3M, computer system 101 detects that user is directing gesture 332 to the computer system 101 itself, thus indicating a desire to have computer system 101 display a visual representation of the collected information associated with application 330. In one or more examples, gesture 332 shares one or more characteristics with gesture 316 described above with respect to FIGS. 3F-3G. In response to detecting gesture 332 directed to computer system 101, the computer system accesses the memory where the collected information associated with application 330 is stored, and based on the information that is stored in the memory displays a visual representation of the application in the three-dimensional environment 302 as illustrated in FIG. 3N.

In the example of FIG. 3N, in response to detecting gesture 332 in FIG. 3M, computer system 101 displays content window 334, which is a visual representation of application 330 running on laptop 304 that is displayed in three-dimensional environment 302. In one or more examples, content window 334 can include a graphical representation of the content that was displayed on laptop 304 while running application 330 (such as illustrated in FIG. 3M). Additionally or alternatively, content window 334 is interactable such the user can interact with the content window 334 in the same manner as they would be able to interact with application 330 running on laptop 306. Thus, in one or more examples, computer system 101 runs its own copy of application 330 using the file and/or files that were transferred to computer system 101 from laptop 304, and the user of the computer system is able to operate application 330 using computer system 101 (displayed within three-dimensional environment 302) in substantially the same manner as they would operate application 330 when running on laptop 304. In one or more examples, the examples of FIGS. 3A-3N are meant as exemplary and should not be seen as limiting to the disclosure.

In one or more examples, method 400 takes place at a computer system in communication with one or more displays and one or more input devices. In one or more examples, the computer system is or includes an electronic device, such as a mobile device (e.g., a tablet, a smartphone, a media player, or a wearable device), or a computer. In one or more examples, the display generation component is a display integrated with the electronic device (optionally a touch screen display), external display such as a monitor, projector, television, or a hardware component (optionally integrated or external) for projecting a user interface or causing a user interface to be visible to one or more users. In one or more examples, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In one or more examples, while presenting, via the one or more displays, a three-dimensional environment including a first object (402), the computer system detects (404) a first gesture performed by a user of the computer system directed to the first object. In one or more examples, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In one or more examples, the three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In one or more examples, the three-dimensional environment includes one or more virtual objects and/or representations of objects in a physical environment of a user of the computer system. Examples of objects include real-world and physical documents, pictures, furniture, which would otherwise exist in a physical environment. In one or more examples, the first gesture is performed by the hand of the user to provide the computer system with an indication that the user wishes to collect information associated with the first object. In one or more examples, the gesture is predefined such that it is visibly different than other gestures used to perform other computing operations, and such that when the device detects that the gesture is being performed, the computer system initiates collection of the information of the object to which the gesture is directed. In one or more examples, a gesture is considered to be directed to an object when the portion of the user used to perform the gesture (e.g., the user's hand) is pointing towards the object and/or is partially obscuring the object (from the viewpoint of the user) as described above.

In one or more examples, in response to detecting the first gesture directed to the first object, the computer system collects (406) information associated with the first object. In one or more examples, the computer system (as part of collecting information associated with the first object) captures an image of the first object. In one or more examples, the computer system, as part of the collecting information about the first object, collects textual data (e.g., text written on the object). Additionally or alternatively, collecting information about the first object includes querying one or more databases with the collected image and/or textual data to determine if the database includes information that is relevant to the object. If a match is found, the matching information can be included as part of the collected information associated with the first object.

In one or more examples, while, presenting, via the display generation component, the three-dimensional environment including a first electronic device (408), wherein the first electronic device is communicatively coupled to the computer system, the computer system detects (410) a second gesture performed by the user directed to the first electronic device. Examples of the first electronic device include, but are limited to: a computing device (e.g., laptop and/or desktop computer), a music player, a television or other media device, a head mounted computing system, and/or a smart speaker.

In one or more examples, in response to detecting the second gesture directed to the first electronic device, transmitting the collected information associated with the first object to the first electronic device. In one or more examples, the second gesture is visually distinguishable by the computer system from the first gesture described above, such that the computer system can discern the difference between the first gesture and the second gesture, thus knowing when to collect information versus when to transmit the collected information. In one or more examples, if the computer system has not stored information associated with any objects in the three-dimensional environment, then the computer system will take no action in response to detecting performance of the second gesture since there is no information that has been collected which can be transmitted. In one or more examples, transmitting the stored information associated with the first object to the first electronic device includes establishing a communication link with the electronic device (e.g., using a wireless or wired communication link such as Bluetooth, near field radiofrequency (RF) protocols, universal serial bus (USB), or other known communication link). In one or more examples, the computer system establishes the communication link to the first electronic device only after ensuring that that the user of the computer system is authorized to transmit information to the electronic device.

In one or more examples, detecting the first gesture directed to the first object comprises detecting the user's hand with one or more fingers of the hand outstretched, followed by a movement of the one or more fingers coming together. In one or more examples, the first gesture is detected by the computer system, only after the computer system detects both portions of the gesture (e.g., the hand outstretched and the fingers coming together have occurred). In one or more examples, in response to detecting that both portions of the gesture have been performed, the computer system begins to collect information associated with the first object as described above.

In one or more examples, the information associated with the first object is collected while the computer system detects that the user is performing the first gesture. In one or more examples, the information is collected by the computer device only while the computing device detects that the first gesture is being performed. In one or more examples, the first gesture is still being “performed” while device detects that fingers are still being held together. In one or more examples, the information associated with the first object is collected while the computer system continues to detect that the first gesture is being performed. In the event that the computer system fails to detect that the first gesture is being performed while the information is being collected, the computer system optionally ceases collecting the information and terminates the process of collecting the information. In one or more examples, once the device detects that the computer system has completed the process of collecting the information, the computer system no longer continues to detect whether the first gesture is being performed.

In one or more examples, while the information associated with the first object is being collected, the computer system displays a first visual indicator within the three-dimensional environment indicating a progress of the collection of the information associated with the first object. In one or more examples, the visual indicator is configured to provide the user with a visual indication of the progress of the information collection (associated with the first object) such that the user can determine how long to hold the first gesture. In one or more examples, the visual indicator includes an animation sequence that is configured to show the progress of the information collection. In one or more examples, the animation sequence includes a progress bar (or circle) that gradually fills up as the information collection progresses, and the animation sequence optionally terminates when the progress bar has completely filled in, which indicates that the information collection has been completed. In one or more examples, the visual indicator ceases to be displayed by the computer system in the event that the information collection process is interrupted or otherwise terminates without having been completed. In one or more examples, the visual indicator, and specifically the animation sequence, also provides a visual indication as to when the information collection has been completed. For instance, the visual indicator includes a check mark or other affirmative visual que that is configured to alert the user that the information collection has completed (and also allows the user to know when they can cease performing the first gesture). In one or more examples, the visual indicator is accompanied by an audio indicator that indicates when the information collection process has completed.

In one or more examples, while the information associated with the first object is being collected but prior to completing the collecting of the information associated with the first object, the computer system detects termination of the first gesture, and in response to detecting termination of the first gesture, ceases collection of the information associated with the first object. In one or more examples, while the information associated with the first object is being collected by the computer system, the user can signal to the computer system to terminate the information collection process (e.g., cease collecting information associated with the first object) by terminating the first gesture before the information collection process has been completed. For instance, in the example of the first gesture including one or more fingers coming together, in response to determining that the user's fingers are no longer pinched together (e.g., no longer performing the first gesture) the device terminates the collection process and forgoes storing the collected information in a memory associated with the computer system. Alternatively, the computer system stores the information that was collected on a memory associated with the computer system before the computer system detected termination of the first gesture. In one or more examples,

In one or more examples, detecting the second gesture comprises detecting the user's hand directed towards the first electronic device with one or more fingers of the hand outstretched. In one or more examples, the second gesture is similar to the first portion of the first gesture (e.g., the fingers outstretched) but in contrast to the first gesture in which the user brings the fingers together, the second gesture only includes the fingers of the user being outstretched and directed to the first electronic device. In one or more examples, being directed to the first electronic device (in the context of the second gesture) shares one or more characteristics with the first gesture being directed to the first object. Thus, the computer system determines that second gesture is directed to the electronic device based on the location and orientation of the hand in the three-dimensional environment when the computer system determines that the hand is performing the second gesture. In one or more examples, if the computer system determines that the user is performing the second gesture, but also determines that the second gesture is not being directed at an electronic device (for instance because an electronic device is not within the field of view of the user), then the computer system forgoes transmitting the collected information associated with the first object. In one or more examples, in response to detecting the second gesture but also in response to detecting that the second gesture is not directed to an electronic device, the computer system displays a visual indicator (such as an X-mark) indicating to the user that no transmission of information has occurred in response to the user performing the second gesture.

In one or more examples, the stored information associated with the first object is transmitted to the first electronic device while the computer system detects that the user is performing the second gesture. In one or more examples, and similar to the example of the first gesture, in response to determining that the user has terminated the second gesture and while the transmission of data to the first electronic device is in progress, the computer system terminates the transmission of the collected information associated with the first object. For example in the case of the second gesture including detecting one or more fingers of the user outstretched, the computer system determines that the second gesture has been terminated when the computer system determines that the fingers that were outstretched (thereby initiating the second gesture) are no longer outstretched.

In one or more examples, while the stored information associated with the first object is being transmitted to the first electronic device, the computer system displays a second visual indicator within the three-dimensional environment indicating a progress of the transmission of the information associated with the first object to the first electronic device. In one or more examples, the second visual indicator shares one or more characteristics with the first visual indicator described above. In one or more examples.

In one or more examples, while the stored information associated with the first object is being transmitted to the first electronic device, but prior to completing the transmitting of the information associated with the first object to the first device, the computer system detects termination of the second gesture, and in response to detecting termination of the second gesture, ceases transmission of the information associated with the first object to the first electronic device. In one or more examples, in response to detecting the termination of the second gesture, the computer system ceases transmission of collected information even if the transmission of the information has not been completed. Alternatively, the computer system completes the transmission of the collected information prior to terminating the transmission, even if the detection of termination of the second gesture occurs prior to the transmission of the information being completed. In one or more examples, in response to determining that the second gesture has been terminated before the transmission has been completed, the computer system displays a visual indicator that is configured to alert the user that the transmission has been terminated without the transmission being completed (such as an X mark similar to the X mark described above). In one or more examples, the visual indicator can also be accompanied by an audio indicator that is configured to alert the user that the transmission has been completed.

In one or more examples, the collected information associated with first object includes a visual scan of the first object. In one or more examples, in response to detecting the first gesture and that the first gesture is directed to the first object, the computer system collects image data associated with the first object. In one or more examples, the image data is acquired from one or more cameras that are associated with the computer system. In one or more examples, the computer system determines the metes and bounds of the first object (using the one or more cameras) and generates an image of the first object within the determined metes and bounds (such that the image data covers an area that is within or even slightly outside the determined metes and bounds of the first object). In one or more examples, the image data is a still image of the first object. Alternatively, the image data includes video data of the first object. In one or more examples, after determining the metes and bounds of the first object, the computer system generates image data of a pre-defined area surrounding and including the first object. In one or more examples, the resolution and/or other visual characteristics of the image data are based on a determination as to the identity or character of the first object. For instance, in response to determining that the first object is a document, the computer system generates image data of the first object at a resolution such that the text on the document can be read by the user of the computer system and/or the user of the first electronic device. In one or more examples, the image data acquired by the computer system is similar in visual quality/characteristics to the type of image data that would be acquired by a scanner if the first object were placed in a scanner and scanned. In one or more examples, the user can provide a predefined visual quality level at which the image data is acquired (for instance by providing settings information in a settings menu).

In one or more examples, in response to completing collection of the information associated with the first object, the computer system compares the collected information associated with the first object with one or more entries in one or more media databases to determine if the collected information matches the one or more entries.

In one or more examples, in accordance with a determination that the collected information associated with the first object matches one or more entries of the one or more media databases, the computer system adds information about the matching one or more entries to the collected information associated with the first object. For example, when the first object includes text that has been scanned as part of the collected information associated with the first object, the scanned text is compared against one or more databases to determine if one or more entries in the database includes information that is relevant or related to the scanned text. The one or more media databases include databases listing music information (e.g., artist, album title, song tracks), movie information, television show information, podcast information, and other compilations of media. Thus, in the example where the collected information associated with the first object includes scanned text, the scanned text is compared against the media databases to see if there is a relevant song, movie, and/or television show that matches the text. In the even that a particular song, movie, and/or show matches the scanned text, that information (e.g., information about the match) is added to the collected information associated with the first object and is thus available to be transmitted to the first electronic device (in response to the computer system detecting the second gesture directed to the first electronic device as described above).

In one or more examples, in response to detecting the second gesture, the computer system determines an identity of the first electronic device. In one or more examples, in accordance with the determined identity of the first electronic device being a first type of electronic device, the computer system transmits a first portion of the stored information associated with the first object to the first electronic device. In one or more examples, in accordance with the determined identity of the first electronic device being a second type of electronic device, different from the first type of electronic device, transmitting a second portion of the stored information, different from the first portion, associated with the first object to the first electronic device. In one or more examples, the computer system customizes the information that is transmitted to the first electronic device based on the type of electronic device that the first electronic device is. For instance, if the first electronic device is determined to be a music player and/or a smart speaker, the computer system transmits a portion of the collected information that would be relevant to a music player and/or smart speaker such as any song titles or artist names that are associated with the first object. In response to receiving the portion of the collected information pertaining to music content, the music player and/or smart speaker can play a song or other music content associated with the transmitted information. Similarly if the first electronic device is determined to be a video player and/or smart tv, the computer system transmits the portion or portions of the collected information associated with the first object pertaining to any associations between the first object and video content (such as matching television shows and/or movies). In one or more examples, and in the example where the first electronic device is a video player and/or smart tv, even though the collected information may include a visual scan of the first object (described above) the visual scan itself is not transmitted to the first electronic device since it is not relevant to the operation of the video player/smart tv.

In one or more examples, the three-dimensional environment includes a second object. In one or more examples, while displaying the three-dimensional environment, after collecting information associated with the first object, and prior to detecting the second gesture, the computer system detects a third gesture performed by the user of the computer system directed to the second object, and in response to detecting the third gesture directed to the second object, collecting information associated with the second object. In one or more examples, and in the event that the user performs the first gesture multiple times directed at multiple objects, the computer system stores the information associated with each time that the computer system detects that the first gesture is performed separately, (e.g., one entry stored per detected occurrence of the fist gesture). Additionally or alternatively, and in the event that the user has directed multiple first gestures to the same object, the computer system accumulates the associated information pertaining to a particular object in a single entry in the memory. Thus, in one or more examples, a single object can have multiple instances of information collected and associated with it and/or multiple separate instances of collected information can pertain the same object.

In one or more examples, in response to collecting information associated with the second object, the computer system displays a stored information user interface in the three-dimensional, wherein the stored information user interface includes a first selectable option associated with the information associated with the first object, and wherein the stored information user interface includes a second selectable option associated with the information associated with the second object. In one or more examples, and in the event that the computer system has collected information pertaining to multiple objects (by detecting multiple instance of the first gesture being performed) the computer system displays a stored information user interface that lists each instance of collected information that is available to be transmitted to an electronic device (in response to the computer system detecting an instance of the second gesture directed to the electronic device). In one or more examples, each entry of the stored information user interface, is a selectable option.

In one or more examples, the computer system detects a first input at the first selectable option associated with the information associated with the first object of the stored information user interface.

In one or more examples, in response to detecting the first input, and in response to detecting the second gesture performed by the user directed to the first electronic device, the computer system transmits the stored information associated with the first object to the electronic device. In one or more examples, in response to detecting that a selectable option of the stored information user interface has been selected, the computer system ensures that the information associated with the entry is transmitted to an electronic device the next time the computer system detects performance of the second gesture directed to the electronic device. Thus, in one or more examples, in response to detecting a second gesture directed to the first electronic device, the computer system transmits the collected information associated with the selectable option that was selected on the stored information user interface.

In one or more examples, in response to detecting the second gesture directed to the first electronic device without having detected the first input, the computer system transmits the stored information associated with the second object to the first electronic device. In one or more examples, if multiple sets of information are stored on the computer system (for instance in response to detecting the first gesture performed multiple times), the computer system in response to detecting the second gesture, will transmit the information associated with the object that was collected when the first gesture was last performed. Thus, the first gestures operate in a last in—first out (LIFO) manner, such that the last information that was stored is the first information that is transmitted in response to detection of the second gesture. In one or more examples, in response to detecting a selection of a selectable option from the stored information user interface, the computer system ceases to operate in a LIFO manner and instead transmits the information associated with the selectable option that was detected as being selected from the stored information user interface.

In one or more examples, the first electronic device is the computer system, and transmitting the stored information associated with the first object to the first electronic device comprises accessing the collected information associated with the first object at a memory of the computer system. In one or more examples, the computer system is configured to detect that the second gesture is being directed to the computer system itself using one or more cameras that are part of and/or communicatively coupled to the computer system. In one or more examples, and as further discussed below, in response to detecting that the second gesture is being directed to the computer system itself, the computer system accesses the memory where the collected information associated with the first object is stored, thus transmitting the collected information associated with the first object to itself.

In one or more examples, in response to detecting the second gesture directed to the computer system, the computer system displays a representation of the first object in the three-dimensional environment. In one or more examples, in response to detecting the second gesture being directed to the computer system, the computer system displays a visual image or other graphical representation of the first object in the three-dimensional environment. For instance, in the example of the first object being a document and the collected information associated with the first object including a scan of the first object, in response to detecting the second gesture being directed to the computer system, the computer system displays the scanned image of the document in a graphic user interface and/or content window that is displayed in the three-dimensional environment. In the example of the collected information including songs, videos, and/or media contact that is relevant to the first object, in response to detecting the second gesture directed to the computer system, the computer system displays a media player and plays the media (e.g., song, move, television show) that is associated with the first object (that association being recorded in the collected information associated with the first object).

In one or more examples, the first object is a computing device. In one or more examples, the first object is a computing device that is visible in the displayed three-dimensional environment. For instance, and in the examples described above, the first object is a laptop or other computing device (tablet, desktop computer) that is in the physical room that is being displayed within the three-dimensional environment. In one or more examples, and as described in further detail below, the computer system detects that the first object (e.g., the object that the first gesture is directed to) is a computing device and in response accesses information from the computing device itself that it uses to display a visual representation in the three-dimensional environment.

In one or more examples, in accordance with the first object being a computing device, and wherein the computing device is executing a first software application, the collected information includes information associated with the application that is running on the computing device. In one or more examples, the application running on the computing device includes a content creation application, a presentation application, a photo application, a video application, a music application, and/or media application. In one or more examples, and in an example where the application is a media application (such as a video application or a music application) the collected information includes information about the application that computing device is currently running. In one or more examples, in response to determining that the first object is a computing device, the computer system transmits a request to the computing device for information associated with the application the computing device is executing, including but not limited any files that the application is using (e.g., photo files, and/or other media files), operations being performed on the files the application is using, settings pertaining to the application, user information associated with the application (assuming the user of the computer system has the proper authorization to access the information) and any other information pertaining to the application that is currently running on the computing device.

It is understood that process 400 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a computer system in communication with one or more displays and one or more input devices:
while presenting, via the one or more displays, a three-dimensional environment including a first object, detecting a first gesture performed by a user of the computer system directed to the first object:
in response to detecting the first gesture directed to the first object, obtaining information associated with the first object;
while presenting, via the one or more displays, the three-dimensional environment including a first electronic device, wherein the first electronic device is communicatively coupled to the computer system, detecting a second gesture performed by the user directed to the first electronic device; and
in response to detecting the second gesture directed to the first electronic device, transmitting the obtained information associated with the first object to the first electronic device.

2. The method of claim 1, wherein the method further comprises:
while the information associated with the first object is being obtained but prior to completing the obtaining of the information associated with the first object, detecting termination of the first gesture; and
in response to detecting termination of the first gesture, ceasing obtaining of the information associated with the first object.

3. The method of claim 1, wherein the obtained information associated with the first object is transmitted to the first electronic device in accordance with the computer system detecting that the user is performing the second gesture.

4. The method of claim 1, wherein the method further comprises:
while the information associated with the first object is being transmitted to the first electronic device, but prior to completing the transmitting of the information associated with the first object to the first electronic device, detecting termination of the second gesture; and
in response to detecting termination of the second gesture, ceasing transmission of the information associated with the first object to the first electronic device.

5. The method of claim 1, wherein the method further comprises:
in response to completing obtaining of the information associated with the first object, comparing the obtained information associated with the first object with one or more entries in one or more media databases to determine if the obtained information matches the one or more entries; and
in accordance with determination that the obtained information associated with the first object matches one or more entries of the one or more media databases, adding information about the matching one or more entries to the obtained information associated with the first object.

6. The method of claim 1, wherein the method further comprises:
in response to detecting the second gesture, determining an identity of the first electronic device:
in accordance with the determined identity of the first electronic device being a first type of electronic device, transmitting a first portion of the information associated with the first object to the first electronic device; and
in accordance with the determined identity of the first electronic device being a second type of electronic device, different from the first type of electronic device, transmitting a second portion of the information, different from the first portion, associated with the first object to the first electronic device.

7. The method of claim 1, wherein the three-dimensional environment includes a second object, and wherein the method further comprises:
while presenting the three-dimensional environment, after obtaining information associated with the first object, and prior to detecting the second gesture, detecting a third gesture performed by the user of the computer system directed to the second object; and
in response to detecting the third gesture directed to the second object, obtaining information associated with the second object.

8. The method of claim 7, wherein the method further comprises:
in response to obtaining information associated with the second object, displaying a stored information user interface in the three-dimensional, wherein the stored information user interface includes a first selectable option associated with the information associated with the first object, and wherein the stored information user interface includes a second selectable option associated with the information associated with the second object;
detecting a first input at the first selectable option associated with the information associated with the first object of the stored information user interface; and
in response to detecting the first input, and in response to detecting the second gesture performed by the user directed to the first electronic device, transmitting the stored information associated with the first object to the electronic device.

9. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while presenting, via the one or more displays, a three-dimensional environment including a first object, detecting a first gesture performed by a user of the computer system directed to the first object:
in response to detecting the first gesture directed to the first object, obtaining information associated with the first object;
while, presenting, via the one or more displays, the three-dimensional environment including a first electronic device, wherein the first electronic device is communicatively coupled to the computer system, detecting a second gesture performed by the user directed to the first electronic device; and
in response to detecting the second gesture directed to the first electronic device, transmitting the obtained information associated with the first object to the first electronic device.

10. The computer system of claim 9, wherein the one or more programs further include instructions for:
while the information associated with the first object is being obtained but prior to completing the obtaining of the information associated with the first object, detecting termination of the first gesture; and
in response to detecting termination of the first gesture, ceasing obtaining of the information associated with the first object.

11. The computer system of claim 9, wherein the obtained information associated with the first object is transmitted to the first electronic device in accordance with the computer system detecting that the user is performing the second gesture.

12. The computer system of claim 9, wherein the one or more programs further include instructions for:
while the information associated with the first object is being transmitted to the first electronic device, but prior to completing the transmitting of the information associated with the first object to the first electronic device, detecting termination of the second gesture; and
in response to detecting termination of the second gesture, ceasing transmission of the information associated with the first object to the first electronic device.

13. The computer system of claim 9, wherein the one or more programs further include instructions for:
in response to completing obtaining of the information associated with the first object, comparing the obtained information associated with the first object with one or more entries in one or more media databases to determine if the obtained information matches the one or more entries; and
in accordance with determination that the obtained information associated with the first object matches one or more entries of the one or more media databases, adding information about the matching one or more entries to the obtained information associated with the first object.

14. The computer system of claim 9, wherein the one or more programs further include instructions for:
in response to detecting the second gesture, determining an identity of the first electronic device:
in accordance with the determined identity of the first electronic device being a first type of electronic device, transmitting a first portion of the information associated with the first object to the first electronic device; and
in accordance with the determined identity of the first electronic device being a second type of electronic device, different from the first type of electronic device, transmitting a second portion of the information, different from the first portion, associated with the first object to the first electronic device.

15. The computer system of claim 9, wherein the three-dimensional environment includes a second object, and wherein the one or more programs further include instructions for:
while presenting the three-dimensional environment, after obtaining information associated with the first object, and prior to detecting the second gesture, detecting a third gesture performed by the user of the computer system directed to the second object; and
in response to detecting the third gesture directed to the second object, obtaining information associated with the second object.

16. The computer system of claim 15, wherein the one or more programs further include instructions for:
in response to obtaining information associated with the second object, displaying a stored information user interface in the three-dimensional, wherein the stored information user interface includes a first selectable option associated with the information associated with the first object, and wherein the stored information user interface includes a second selectable option associated with the information associated with the second object;
detecting a first input at the first selectable option associated with the information associated with the first object of the stored information user interface; and in response to
detecting the first input, and in response to detecting the second gesture performed by the user directed to the first electronic device, transmitting the stored information associated with the first object to the electronic device.

17. A non-transitory computer readable storage medium storing one or more programs, the one or more programs comprising instructions, which when executed by one or more processors of a computer system in communication with one or more displays and one or more input devices, cause the computer system to:
while presenting, via the one or more displays, a three-dimensional environment including a first object, detect a first gesture performed by a user of the computer system directed to the first object:
in response to detecting the first gesture directed to the first object, obtain information associated with the first object;
while presenting, via the one or more displays, the three-dimensional environment including a first electronic device, wherein the first electronic device is communicatively coupled to the computer system, detect a second gesture performed by the user directed to the first electronic device; and
in response to detecting the second gesture directed to the first electronic device, transmit the obtained information associated with the first object to the first electronic device.

18. The non-transitory computer readable storage medium of claim 17, wherein the one or more programs further include instructions for:
while the information associated with the first object is being obtained but prior to completing the obtaining of the information associated with the first object, detecting termination of the first gesture; and
in response to detecting termination of the first gesture, ceasing obtaining of the information associated with the first object.

19. The non-transitory computer readable storage medium of claim 17, wherein the obtained information associated with the first object is transmitted to the first electronic device in accordance with the computer system detecting that the user is performing the second gesture.

20. The non-transitory computer readable storage medium of claim 17, wherein the one or more programs further include instructions for:
while the information associated with the first object is being transmitted to the first electronic device, but prior to completing the transmitting of the information associated with the first object to the first electronic device, detecting termination of the second gesture; and
in response to detecting termination of the second gesture, ceasing transmission of the information associated with the first object to the first electronic device.

21. The non-transitory computer readable storage medium of claim 17, wherein the one or more programs further include instructions for:
in response to completing obtaining of the information associated with the first object, comparing the obtained information associated with the first object with one or more entries in one or more media databases to determine if the obtained information matches the one or more entries; and
in accordance with determination that the obtained information associated with the first object matches one or more entries of the one or more media databases, adding information about the matching one or more entries to the obtained information associated with the first object.

22. The non-transitory computer readable storage medium of claim 17, wherein the one or more programs further include instructions for:
in response to detecting the second gesture, determining an identity of the first electronic device:
in accordance with the determined identity of the first electronic device being a first type of electronic device, transmitting a first portion of the information associated with the first object to the first electronic device; and
in accordance with the determined identity of the first electronic device being a second type of electronic device, different from the first type of electronic device, transmitting a second portion of the information, different from the first portion, associated with the first object to the first electronic device.

23. The non-transitory computer readable storage medium of claim 17, wherein the three-dimensional environment includes a second object, and wherein the one or more programs further include instructions for:
while presenting the three-dimensional environment, after obtaining information associated with the first object, and prior to detecting the second gesture, detecting a third gesture performed by the user of the computer system directed to the second object; and
in response to detecting the third gesture directed to the second object, obtaining information associated with the second object.

24. The non-transitory computer readable storage medium of claim 23, wherein the one or more programs further include instructions for:
in response to obtaining information associated with the second object, displaying a stored information user interface in the three-dimensional, wherein the stored information user interface includes a first selectable option associated with the information associated with the first object, and wherein the stored information user interface includes a second selectable option associated with the information associated with the second object;
detecting a first input at the first selectable option associated with the information associated with the first object of the stored information user interface; and in response to
detecting the first input, and in response to detecting the second gesture performed by the user directed to the first electronic device, transmitting the stored information associated with the first object to the electronic device.
